(19) United States
(12) Patent Application Publication
(10) Pub. No.: US 2024/0055740 A1
(43) Pub. Date: Feb. 15, 2024

(54) BATTERY

(71) Applicant: Panasonic Intellectual Property Management Co., Ltd., Osaka (JP)

(72) Inventors: Akira KAWASE, Osaka (JP); Kazuyoshi HONDA, Osaka (JP); Koichi HIRANO, Osaka (JP)

(21) Appl. No.: 18/496,550

(22) Filed: Oct. 27, 2023

Related U.S. Application Data
(63) Continuation of application No. PCT/JP2022/014284, filed on Mar. 25, 2022.

(30) Foreign Application Priority Data
May 10, 2021 (JP) 2021-080077

(51) Int. Cl. H01M 50/586; H01M 10/0585; H01M 50/548; H01M 50/531; H01M 50/107; H01M 50/109; H01M 50/105

(52) U.S. Cl. CPC H01M 50/586; H01M 10/0585; H01M 50/548; H01M 50/531; H01M 50/107; H01M 50/109; H01M 50/105

(57) ABSTRACT

A battery includes: a power generation element including battery cells each of which includes an electrode layer, a counter-electrode layer, and a solid electrolyte layer located between the electrode layer and the counter-electrode layer, and which are stacked; an electrode insulating layer covering an electrode layer among the electrode layers at a side surface of the power generation element; and a counter-electrode terminal covering the side surface and the electrode insulating layer, and electrically connected to a counter-electrode layer among the counter-electrode layers. At least some of the battery cells are connected in parallel. At the side surface, the electrode insulating layer covers from an electrode layer among the electrode layers to a part of a corresponding one of the counter-electrode layers along a stacking direction of the power generation element.

### CROSS REFERENCE TO RELATED APPLICATIONS

This is a continuation application of PCT International Application No. PCT/JP2022/014284 filed on Mar. 25, 2022, designating the United States of America, which is based on and claims priority of Japanese Patent Application No. 2021-080077 filed on May 10, 2021. The entire disclosures of the above-identified applications, including the specifications, drawings and claims are incorporated herein by reference in their entirety.

### FIELD

The present disclosure relates to a battery.

### BACKGROUND

In recent years, a battery formed by connecting multiple battery cells in parallel has been known (for example, see Patent Literature (PTL) 1 and PTL 2).

### CITATION LIST

### Patent Literature

PTL 1: International Publication WO 2012/020699
PTL 2: Japanese Unexamined Patent Application Publication No. 2013-120717

### SUMMARY

### Technical Problem

There is a demand for the further improvement of the battery property of the conventional battery.

In view of this, the present disclosure provides a high-performance battery.

### Solution to Problem

A battery according to one aspect of the present disclosure includes: a power generation element including a plurality of battery cells each of which includes an electrode layer, a counter-electrode layer, and a solid electrolyte layer located between the electrode layer and the counter-electrode layer, and which are stacked; a first insulating member covering an electrode layer among the electrode layers at a first side surface of the power generation element; and a first terminal electrode covering the first side surface and the first insulating member, and electrically connected to a counter-electrode layer among the counter-electrode layers. At least some of the plurality of battery cells are connected in parallel. At the first side surface, the first insulating member covers from an electrode layer among the electrode layers to a part of a corresponding one of the counter-electrode layers along a stacking direction of the power generation element.

### Advantageous Effects

According to the present disclosure, it is possible to provide a high-performance battery.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a cross-sectional view illustrating a cross-sectional configuration of a battery according to an embodiment.

FIG. 2 is a top view of the battery according to the embodiment.

FIG. 3A is a cross-sectional view of an example of a battery cell included in a power generation element according to the embodiment.

FIG. 3B is a cross-sectional view of another example of the battery cell included in the power generation element according to the embodiment.

FIG. 3C is a cross-sectional view of another example of the battery cell included in the power generation element according to the embodiment.

FIG. 4 is a cross-sectional view of the power generation element according to the embodiment.

FIG. 5 is a side view illustrating a positional relationship between the first side surface of the power generation element and an electrode insulating layer and a counter-electrode terminal which are formed on the first side surface, according to the embodiment.

FIG. 6 is a side view illustrating a positional relationship between the second side surface of the power generation element and a counter-electrode insulating layer and an electrode terminal which are formed on the second side surface, according to the embodiment.

FIG. 7 is a cross-sectional view of a coin battery including the battery according to the embodiment.

FIG. 8 is a cross-sectional view of a laminated battery including the battery according to the embodiment.

FIG. 9 is a cross-sectional view illustrating a cross-sectional configuration of a battery according to Variation 1.

FIG. 10 is a cross-sectional view illustrating a cross-sectional configuration of a battery according to Variation 2.

FIG. 11A is a cross-sectional view illustrating a step of a method of manufacturing a battery according to the embodiment or each variation.

FIG. 11B is a cross-sectional view illustrating a step of the method of manufacturing the battery according to the embodiment or each variation.

FIG. 11C is a cross-sectional view illustrating a step of the method of manufacturing the battery according to the embodiment or each variation.

FIG. 11D is a cross-sectional view illustrating a step of the method of manufacturing the battery according to the embodiment or each variation.

FIG. 11E is a cross-sectional view illustrating a step of the method of manufacturing the battery according to the embodiment or each variation.

FIG. 11F is a cross-sectional view illustrating a step of the method of manufacturing the battery according to the embodiment or each variation.

FIG. 11G is a cross-sectional view illustrating a step of the method of manufacturing the battery according to the embodiment or each variation.

FIG. 11H is a cross-sectional view illustrating a step of the method of manufacturing the battery according to the embodiment or each variation.

### DESCRIPTION OF EMBODIMENT

(Outline of Present Disclosure)

A battery according to one aspect of the present disclosure includes: a power generation element including a plurality of battery cells each of which includes an electrode layer, a counter-electrode layer, and a solid electrolyte layer located between the electrode layer and the counter-electrode layer, and which are stacked; a first insulating member covering an electrode layer among the electrode layers at a first side surface of the power generation element; and a first terminal electrode covering the first side surface and the first insulating member, and electrically connected to a counter-electrode layer among the counter-electrode layers. At least some of the plurality of battery cells are connected in parallel. At the first side surface, the first insulating member covers from an electrode layer among the electrode layers to a part of a corresponding one of the counter-electrode layers along a stacking direction of the power generation element. The corresponding one of the counter-electrode layers means the counter-electrode layer included in the battery cell including the electrode layer among the electrode layers.

With this, it is possible to achieve a high-performance battery. For example, the first insulating member covers the electrode layer at the first side surface, and thus it is possible to prevent a short circuit between the counter-electrode layer and the electrode layer through the first terminal electrode. Moreover, the first insulating member covers to a part of the counter-electrode layer, and thus it is possible to sufficiently prevent the electrode layer from being exposed without being covered with the first insulating member. Moreover, the adhesion of the first insulating member to the power generation element is increased, and thus removal of the first insulating member is prevented. Accordingly, the reliability of the battery can be enhanced. As described above, the reliability of the battery can be enhanced, and thus it is possible to achieve a high-performance battery.

Moreover, for example, the counter-electrode layer may include: a counter-electrode current collector; and a counter-electrode active material layer located between the counter-electrode current collector and the solid electrolyte layer. The first insulating member may cover from the electrode layer to at least a part of the counter-electrode active material layer, and need not cover the counter-electrode current collector.

With this, in general, the counter-electrode active material layer includes a powder-like material, and thus the end surface of the counter-electrode active material layer has very fine unevenness. This improves the adhesion strength of the first insulating member and enhances the reliability of insulation. Moreover, the counter-electrode current collector is exposed, and thus it is possible to sufficiently ensure the electrical connection between the first terminal electrode and the counter-electrode current collector.

Moreover, for example, a thickness of the counter-electrode current collector may be less than or equal to 20 μm.

With this, it is possible to achieve improvement of energy density, improvement of output density, reduction in material cost, and the like.

Moreover, for example, the battery according to one aspect of the present disclosure may further include an outer counter-electrode current collector disposed at a first main surface of the power generation element. The outer counter-electrode current collector includes a first extended portion extending outward from the first main surface, and the first extended portion may be connected to the first terminal electrode.

With this, the outer counter-electrode current collector is provided, and thus can be used as an extraction electrode to the outside. For example, a large main surface can be ensured for the outer counter-electrode current collector, and thus a large external terminal can be connected. Accordingly, the contact area can be increased to decrease the connection resistance. Accordingly, it is possible to enhance the high current characteristics of the battery.

Moreover, for example, the battery according to one aspect of the present disclosure may further include an insulating layer located between the outer counter-electrode current collector and the first main surface.

With this, when a part of the electrode layer is the first main surface, the contact between the outer counter-electrode current collector and the electrode layer can be prevented. In other words, a short circuit between the counter-electrode layer and the electrode layer through the outer counter-electrode current collector can be prevented, and thus it is possible to enhance the reliability of the battery.

Moreover, for example, in plan view, contour of the electrode layer, contour of the counter-electrode layer, and contour of the solid electrolyte layer may coincide with one another.

With this, in plan view, none of the layers is protruded, and thus it is possible to prevent a short circuit caused by lithium dendrites. Moreover, in plan view, each of the layers has the same area, and thus the active area of the battery cell can be increased. Accordingly, it is possible to increase the battery capacity.

Moreover, for example, the battery according to one aspect of the present disclosure may further includes: a second insulating member covering a counter-electrode layer among the counter-electrode layers at a second side surface of the power generation element; and a second terminal electrode covering the second side surface and the second insulating member, and electrically connected to an electrode layer among the electrode layers. At the second side surface, the second insulating member may cover from a counter-electrode layer among the counter-electrode layers to a part of a corresponding one of the electrode layers along the stacking direction of the power generation element.

With this, it is possible to achieve a higher performance battery. For example, the second insulating member covers the counter-electrode layer at the second side surface, and thus it is possible to prevent a short circuit between the counter-electrode layer and the electrode layer through the second terminal electrode. Moreover, the second insulating member covers to a part of the electrode layer, and thus it is possible to sufficiently prevent the counter-electrode layer from being exposed without being covered with the second insulating member. Moreover, the adhesion of the second insulating member to the power generation element is increased, and thus removal of the second insulating member is prevented. Accordingly, it is possible to further enhance the reliability of the battery.

Moreover, for example, the electrode layer may include: an electrode current collector; and an electrode active material layer located between the electrode current collector and the solid electrolyte layer. The second insulating member covers from the counter-electrode layer to at least a part of the electrode active material layer, and need not cover the electrode current collector.

With this, in general, the electrode active material layer includes a powder-like material, and thus the end surface of the electrode active material layer has very fine unevenness. This improves the adhesion strength of the second insulating member and enhances the reliability of insulation. Moreover, the electrode current collector is exposed, and thus it is possible to sufficiently ensure the electrical connection between the second terminal electrode and the electrode current collector.

Moreover, for example, a thickness of the electrode current collector may be less than or equal to 20 μm.

With this, it is possible to achieve improvement of energy density, improvement of output density, reduction in material cost, and the like.

Moreover, for example, the battery according to one aspect of the present disclosure may further include an outer electrode current collector disposed at a second main surface of the power generation element. The outer electrode current collector includes a second extended portion extending outward from the second main surface, and the second extended portion may be connected to the second terminal electrode.

With this, the outer electrode current collector is provided, and thus can be used as an extraction electrode to the outside. For example, a large main surface can be ensured for the outer electrode current collector, and thus a large external terminal can be connected. Accordingly, the contact area can be increased to decrease the connection resistance. Accordingly, it is possible to enhance the high current characteristics of the battery.

Moreover, for example, all the plurality of battery cells may be connected in parallel.

With this, all the battery cells are electrically connected in parallel. This can prevent overcharging or over-discharging of a specific battery cell due to the capacity difference of the battery cells. Accordingly, it is possible to further enhance the reliability of the battery.

Moreover, for example, some of the plurality of battery cells may be connected in series.

With this, it is possible to achieve a battery matched to a required capacity and voltage.

Moreover, for example, the solid electrolyte layer may include a lithium-ion conducting solid electrolyte.

Moreover, for example, a shape of the power generation element is cylindrical, and the first side surface and the second side surface may be each a different part of a cylindrical side surface. For example, the battery is a coin battery.

With this, in the coin battery, multiple battery cells can be connected in parallel, and thus it is possible to achieve a high-capacity coin battery.

Moreover, for example, the battery is sealed with a laminate film.

With this, it is possible to achieve a high-performance laminated battery.

Embodiments are described in details below with reference to the drawings.

Each of the embodiments described below shows a general or specific example. Numerical values, shapes, materials, constituent elements, the arrangement and connection of the constituent elements, steps, the order of the steps, and the like shown in the following embodiments are examples, and are not intended to limit the present disclosure. Among the constituent elements in the following embodiments, constituent elements which are not recited in the independent claims are described as optional constituent elements.

The drawings are schematic views and are not exactly shown. Hence, for example, scales and the like are not necessarily the same in the drawings. In the drawings, substantially the same components are identified with the same reference signs, and repeated descriptions are omitted or simplified.

In the present specification, terms such as parallel and orthogonal which indicate relationships between elements, terms such as rectangular and cuboid which indicate the shapes of elements, and numerical ranges are expressions which not only indicate exact meanings but also indicate substantially equivalent ranges such as a range including a several percent difference.

In the present specification and the drawings, an x-axis, a y-axis, and a z-axis indicate three axes of a three-dimensional orthogonal coordinate system. The x-axis and the y-axis each correspond to a direction parallel to the main surface of the power generation element. The z-axis corresponds to the stacking direction of a plurality of battery cells included in the power generation element.

In the present specification, the “stacking direction” coincides with a direction normal to the main surfaces of a current collector and an active material layer. In the present specification, the “plan view” is a view when viewed in a direction perpendicular to the main surface of the power generation element, excluding a specified case such as single application. Note that, the “plan view of a surface” such as the “plan view of the first side surface” is a view when the “surface” is viewed from the front.

In the present specification, terms of “upward” and “downward” do not indicate an upward direction (vertically upward) and a downward direction (vertically downward) in absolute spatial recognition but are used as terms for defining a relative positional relationship based on a stacking order in a stacking configuration. The terms of “upward” and “downward” are applied not only to a case where two constituent elements are spaced with another constituent element present between the two constituent elements but also to a case where two constituent elements are arranged in close contact with each other to be in contact with each other. In the following description, the negative side of the z-axis is assumed to be “downward” or a “downward side”, and the positive side of the z-axis is assumed to be “upward” or an “upward side”.

In the present specification, unless otherwise specified, ordinal numbers such as “first” and “second” do not mean the number or order of constituent elements but are used to avoid confusion of similar constituent elements and to distinguish between them.

### Embodiment

The following describes the configuration of a battery according to an embodiment.

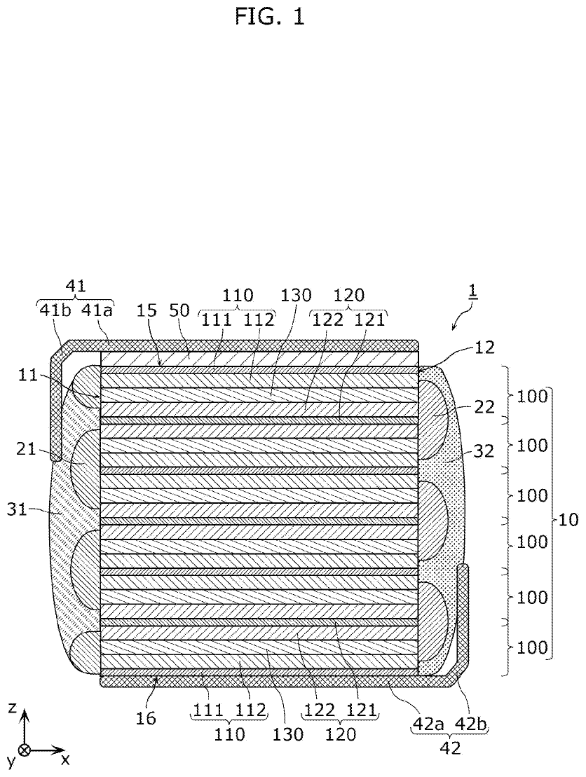

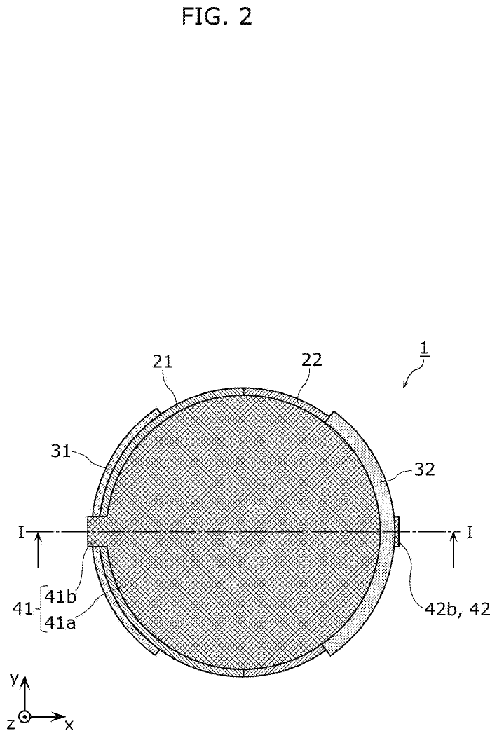

FIG. 1 is a cross-sectional view illustrating a cross-sectional configuration of battery 1 according to the present embodiment. FIG. 2 is a top view of battery 1 according to the present embodiment. Note that FIG. 1 shows a cross section taken along line I-I shown in FIG. 2. In FIG. 2, the same hatching as each layer shown in FIG. 1 is applied to clarify the relationship between components.

As shown in FIG. 2, the shape of battery 1 in plan view is substantially circular. In other words, the shape of battery 1 is substantially flattened cylindrical. Here, “flattened” means that the thickness (i.e., the length in the z-axis direction) is shorter than the maximum width of the main surface. Although the details are described later, battery 1 is used as a coin battery. Note that the shape of battery 1 in plan view may be polygonal such as rectangular, square, hexagonal, or octagonal, or may be oval or the like. Note that, in a cross-sectional view such as FIG. 1, the thickness of each layer is exaggerated to clarify the layer structure of power generation element 10.

As shown in FIG. 1, battery 1 includes power generation element 10, electrode insulating layer 21, counter-electrode insulating layer 22, counter-electrode terminal 31, electrode terminal 32, outer counter-electrode current collector 41, outer electrode current collector 42, and insulating layer 50. Battery 1 is, for example, an all-solid-state battery.

[1. Power Generation Element]

Firstly, the specific configuration of power generation element is described.

As shown in FIG. 1, power generation element 10 includes side surfaces 11 and 12, and main surfaces 15 and 16. In the present embodiment, main surfaces 15 and 16 are both flat.

Side surface 11 is an example of the first side surface. Side surface 12 is an example of the second side surface. In the present embodiment, power generation element 10 is flattened cylindrical-shaped. Accordingly, side surfaces 11 and 12 are each a different part of the cylindrical side surface and face away from each other. For example, in plan view, side surface 12 is located on the line connecting a point in side surface 11 and the center of main surface 15.

Side surface 15 is an example of the first main surface. Side surface 16 is an example of the second main surface. Side surfaces 15 and 16 face away from each other, and are parallel to each other. Main surface 15 is the uppermost surface of power generation element 10. Main surface 16 is the lowermost surface of power generation element 10.

As shown in FIG. 1, power generation element 10 includes multiple battery cells 100. Battery cell 100 is a minimum unit of the battery, and also referred to as a unit cell. Multiple battery cells 100 are electrically connected in parallel and stacked. In Embodiment 1, all battery cells 100 of power generation element 10 are electrically connected in parallel. In the example shown in FIG. 1, the number of battery cells 100 of power generation element 10 is six, but not limited to this. For example, the number of battery cells 100 of power generation element 10 may be an even number such as two or four, or an odd number such as three or five.

Each of battery cells 100 includes electrode layer 110, counter electrode layer 120, and solid electrolyte layer 130. Electrode layer 110 includes electrode current collector 111 and electrode active material layer 112. Counter electrode layer 120 includes counter-electrode current collector 121 and counter-electrode active material layer 122. In each of battery cells 100, electrode current collector 111, electrode active material layer 112, solid electrolyte layer 130, counter-electrode active material layer 122, and counter-electrode current collector 121 are stacked in this order in the z-axis direction.

Note that electrode layer 110 is one of the positive electrode layer or the negative electrode layer of battery cell 100. Counter-electrode layer 120 is the other of the positive electrode layer or the negative electrode layer of battery cell 100. The following describes, as an example, a case where electrode layer 110 is the negative electrode layer, and counter-electrode layer 120 is the positive electrode layer.

The configurations of battery cells 100 are substantially the same. In two adjacent battery cells 100, the order of arrangement of the layers included in one of battery cells 100 is reversed. In other words, battery cells 100 are arranged and stacked in the z-axis direction while alternately reversing the order of arrangement of the layers included in each of battery cells 100. In the present embodiment, the number of battery cells 100 is an even number, and thus the lowermost layer and the uppermost layer of power generation element 10 are the current collectors of the same polarity.

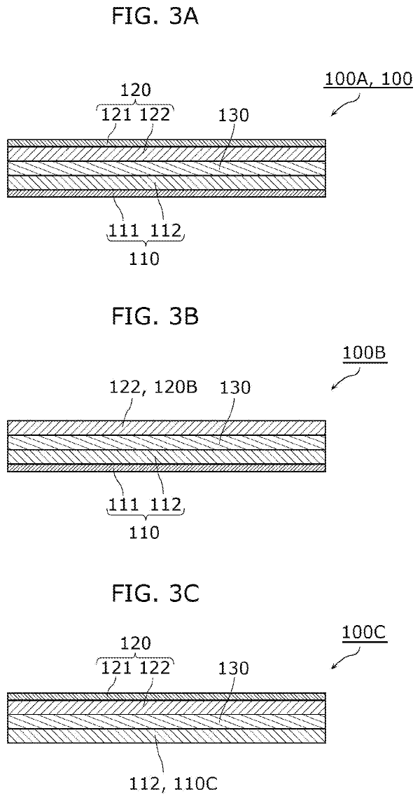

The following describes each of the layers of battery cell 100 with reference to FIG. 3A. FIG. 3A is a cross-sectional view of battery cell 100 included in power generation element 10 according to the present embodiment.

Each of electrode current collector 111 and counter-electrode current collector 121 is a conductive member which is foil-shaped, plate-shaped, or mesh-shaped. Each of electrode current collector 111 and counter-electrode current collector 121 may be, for example, a conductive thin film. For example, metals such as stainless steel (SUS), aluminum (Al), copper (Cu), and nickel (Ni) can be used as the material of electrode current collector 111 and counter-electrode current collector 121. Electrode current collector 111 and counter-electrode current collector 121 may be each formed using a different material.

The thickness of each of electrode current collector 111 and counter-electrode current collector 121 is, for example, at least 5 μm and at most 100 μm, but not limited to this. The thickness of each of electrode current collector 111 and counter-electrode current collector 121 may be 20 μm or less. The current-collector thickness of 20 μm or less allows improvement of energy density, improvement of output density, reduction in material cost, and the like. In the present embodiment, single battery cells 100 are connected in parallel and stacked. Accordingly, the thickness of power generation element can be kept small even when the number of battery cells connected in parallel is increased, thereby contributing to the improvement of energy density. An increase in the number of battery cells connected in parallel increases the number of current collectors, and thus a reduction in the thickness of the current collector is more useful to prevent an increase in the thickness of power generation element 10.

Electrode active material layer 112 is in contact with the main surface of electrode current collector 111. Note that electrode current collector 111 may include a current collector layer which is provided in a part in contact with electrode active material layer 112 and which includes a conductive material. Counter-electrode active material layer 122 is in contact with the main surface of counter-electrode current collector 121. Note that counter-electrode current collector 121 may include a current collector layer which is provided in a part in contact with counter-electrode active material layer 122 and which includes a conductive material.

Electrode active material layer 112 is arranged on the main surface of electrode current collector 111 on the side of counter-electrode layer 120. Electrode active material layer 112 includes, for example, a negative electrode active material as an electrode material. Electrode active material layer 112 is opposed to counter-electrode active material layer 122.

As the negative electrode active material contained in electrode active material layer 112, for example, a negative electrode active material such as graphite or metallic lithium can be used. As the material of the negative electrode active material, various types of materials which can withdraw and insert ions of lithium (Li), magnesium (Mg), or the like can be used.

As a material contained in electrode active material layer 112, for example, a solid electrolyte such as an inorganic solid electrolyte may be used. As the inorganic solid electrolyte, for example, a sulfide solid electrolyte or an oxide solid electrolyte can be used. As the sulfide solid electrolyte, for example, a mixture of lithium sulfide (Li₂S) and phosphorus pentasulfide (P₂S₅) can be used. As the material contained in electrode active material layer 112, for example, a conductive material such as acetylene black, or a binder for binding such as polyvinylidene fluoride may be used.

A paste-like paint in which the material contained in electrode active material layer 112 is kneaded together with a solvent is applied on the main surface of electrode current collector 111 and is dried, and thus electrode active material layer 112 is produced. After the drying, electrode layer 110 (which is also referred to as an electrode plate) including electrode active material layer 112 and electrode current collector 111 may be pressed so that the density of electrode active material layer 112 is increased. The thickness of electrode active material layer 112 is, for example, at least 5 μm and at most 300 μm, but not limited to this.

Counter-electrode active material layer 122 is arranged on the main surface of counter-electrode current collector 121 on the side of electrode layer 110. Counter-electrode active material layer 122 is, for example, a layer which includes a positive electrode material such as an active material. The positive electrode material is a material which forms the counter electrode of the negative electrode material. Counter-electrode active material layer 122 includes, for example, a positive electrode active material.

As the positive electrode active material contained in counter-electrode active material layer 122, for example, a positive electrode active material such as lithium cobaltate composite oxide (LCO), lithium nickelate composite oxide (LNO), lithium nnanganate composite oxide (LMO), lithium-manganese-nickel composite oxide (LMNO), lithium-manganese-cobalt composite oxide (LMCO), lithium-nickel-cobalt composite oxide (LNCO), or lithium-nickel-manganese-cobalt composite oxide (LNMCO) can be used. As the material of the positive electrode active material, various types of materials which can withdraw and insert ions of Li, Mg, or the like can be used.

As a material contained in counter-electrode active material layer 122, for example, a solid electrolyte such as an inorganic solid electrolyte may be used. As the inorganic solid electrolyte, for example, a sulfide solid electrolyte or an oxide solid electrolyte can be used. As the sulfide solid electrolyte, for example, a mixture of Li₂S and P₂S₅ can be used. The surface of the positive electrode active material may be coated with a solid electrolyte. As the material contained in counter-electrode active material layer 122, for example, a conductive material such as acetylene black, or a binder for binding such as polyvinylidene fluoride may be used.

A paste-like paint in which the material contained in counter-electrode active material layer 122 is kneaded together with a solvent is applied on the main surface of counter-electrode current collector 121 and is dried, and thus counter-electrode active material layer 122 is produced. After the drying, counter-electrode layer 120 (which is also referred to as a counter-electrode plate) including counter-electrode active material layer 122 and counter-electrode current collector 121 may be pressed so that the density of counter-electrode active material layer 122 is increased. The thickness of counter-electrode active material layer 122 is, for example, at least 5 μm and at most 300 μm, but not limited to this.

Solid electrolyte layer 130 is arranged between electrode active material layer 112 and counter-electrode active material layer 122. Solid electrolyte layer 130 is in contact with electrode active material layer 112 and counter-electrode active material layer 122. Solid electrolyte layer 130 includes an electrolyte material. As the electrolyte material, a common electrolyte for the battery can be used. The thickness of solid electrolyte layer 130 may be at least 5 μm and at most 300 μm or may be at least 5 μm and at most 100 μm.

Solid electrolyte layer 130 includes a solid electrolyte. As the solid electrolyte, for example, a solid electrolyte such as an inorganic solid electrolyte can be used. As the inorganic solid electrolyte, for example, a sulfide solid electrolyte or an oxide solid electrolyte can be used. As the sulfide solid electrolyte, for example, a mixture of Li₂S and P₂S₅ can be used. Note that solid electrolyte layer 130 may contain, in addition to the electrolyte material, for example, a binder for binding such as polyvinylidene fluoride.

In Embodiment 1, electrode active material layer 112, counter-electrode active material layer 122, and solid electrolyte layer 130 are maintained in the shape of parallel flat plates. With this, it is possible to suppress the occurrence of a crack or a collapse caused by bending. Note that electrode active material layer 112, counter-electrode active material layer 122, and solid electrolyte layer 130 may be smoothly curved together.

In Embodiment 1, when viewed from the z-axis direction, the end surface of counter-electrode current collector 121 on the side of side surface 11 and the end surface of electrode layer 110 on the side of side surface 11 are aligned. More specifically, when viewed from the z-axis direction, the end surface of counter-electrode current collector 121 on the side of side surface 11 and the end surface of electrode current collector 111 on the side of side surface 11 are aligned. The same is true for the end surface of counter-electrode current collector 121 on the side of side surface 12 and the end surface of electrode current collector 111 on the side of side surface 12.

More specifically, in battery cell 100, electrode current collector 111, electrode active material layer 112, solid electrolyte layer 130, counter-electrode active material layer 122, and counter-electrode current collector 121 are the same in shape and size, and thus their contours coincide with one another. In other words, battery cell 100 is flattened cylinder-like flat-plate-shaped.

As shown in FIG. 1, in the present embodiment, a current collector is shared between two adjacent battery cells 100. For example, battery cell 100 of the lowermost layer and battery cell 100 of the second lowest layer share electrode current collector 111.

More specifically, as shown in FIG. 1, in multiple battery cells 100, two adjacent electrode layers 110 share own electrode current collector 111. Electrode active material layer 112 is provided on the both main surfaces of shared electrode current collector 111. Two adjacent counter-electrode layers 120 share own counter-electrode current collector 121. Counter-electrode active material layer 122 is provided on the both main surfaces of shared counter-electrode current collector 121.

Such battery 1 is formed by stacking not only battery cell 100 shown in FIG. 3A but also battery cell 100B shown in FIG. 3B and battery cell 100C shown in FIG. 3C in combination. Note that, in this disclosure, battery cell 100 shown in FIG. 3A is referred to as battery cell 100A.

Battery cell 100B shown in FIG. 3B has a configuration in which counter-electrode current collector 121 is removed from battery cell 100A shown in FIG. 3A. In other words, counter-electrode layer 120B of battery cell 100B includes only counter-electrode active material layer 122.

Battery cell 100C shown in FIG. 3C has a configuration in which electrode current collector 111 is removed from battery cell 100A shown in FIG. 3A. In other words, electrode layer 110C of battery cell 100C includes only electrode active material layer 112.

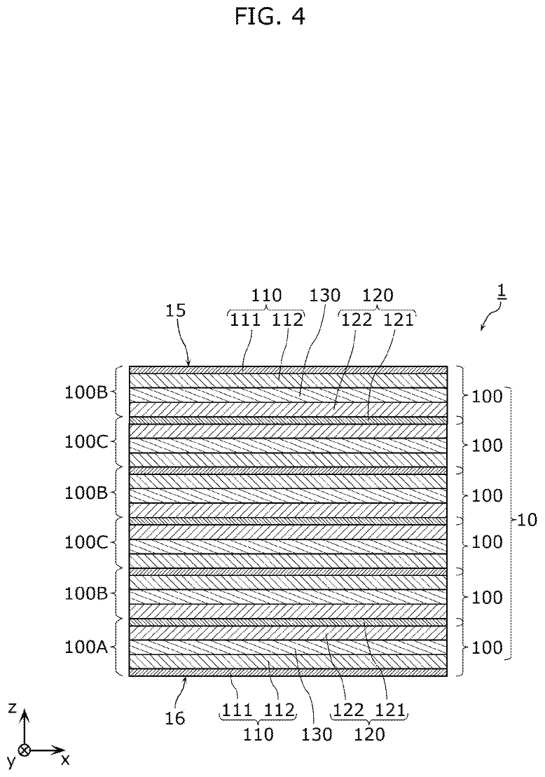

FIG. 4 is a cross-sectional view illustrating power generation element 10 according to the present embodiment. FIG. 4 is a diagram in which only power generation element 10 is extracted from FIG. 1. As shown in FIG. 4, battery cell 100A is located in the lowermost layer, and battery cells 1008 and 100C are alternately stacked upward. In doing so, battery cell 100B shown in FIG. 3B is turned upside down and stacked. In this way, power generation element 10 is formed.

Note that the method of forming power generation element 10 is not limited to this. For example, battery cell 100A may be located in the uppermost layer. Alternatively, battery cell 100A may be located in a layer different from both the uppermost layer and the lowermost layer. Moreover, multiple battery cells 100A may be used. Moreover, a unit of two battery cells 100 sharing a current collector may be formed by performing double-sided coating on one current collector. A specific example of the manufacturing method is described later.

As described above, power generation element 10 according to the present embodiment includes battery cells 100 all connected in parallel, and does not include battery cells connected in series. Accordingly, in charging and discharging battery 1, unevenness in the charge and discharge state caused by the capacity difference of battery cells 100 is unlikely to occur. This considerably reduces the possibility of overcharging or over-discharging of some of multiple battery cells 100, thereby enhancing the reliability of battery 1.

[2. Insulating Layer]

Next, electrode insulating layer 21 and counter-electrode insulating layer 22 are described.

Electrode insulating layer 21 is one example of the first insulating member. As shown in FIG. 1, electrode insulating layer 21 covers electrode layer 110 at side surface 11. More specifically, electrode insulating layer 21 completely covers electrode current collector 111 and electrode active material layer 112 at side surface 11.

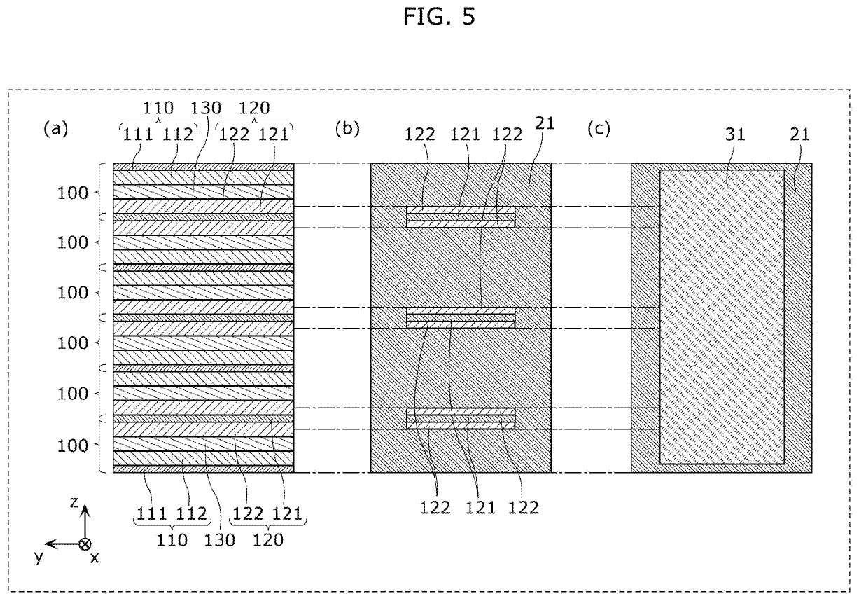

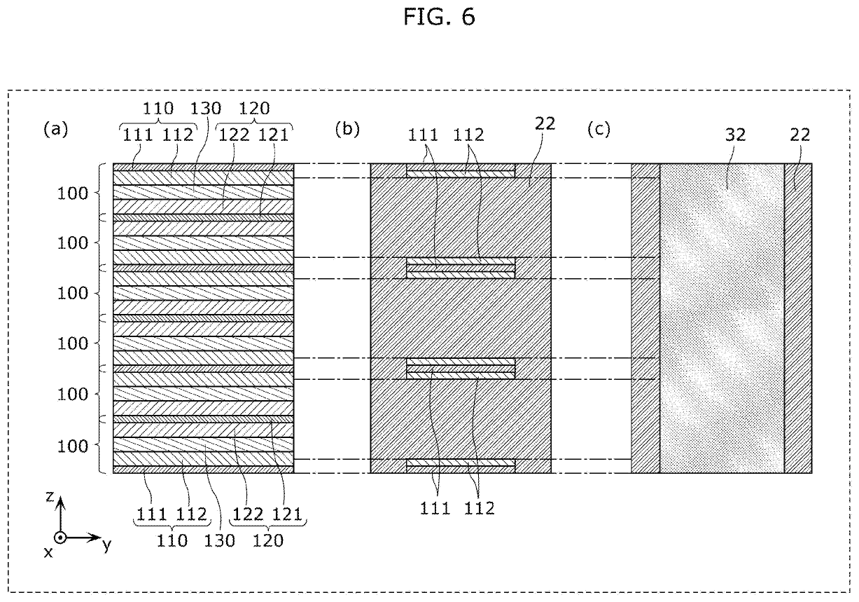

FIG. 5 is a side view illustrating a positional relationship between first side surface 11 of power generation element 10 and electrode insulating layer 21 and counter-electrode terminal 31 which are formed on first side surface 11, according to Embodiment 1. FIG. schematically illustrates a half of the cylindrical side surface of power generation element 10 on the x-axis negative side. Note that in FIG. 5, the same hatching as each layer shown in FIG. 1 is applied to the end surface of each layer exposed in side surface 11. The same is true for FIG. 6 described below.

Part (a) of FIG. 5 is a side view of power generation element 10, and also a plan view of side surface 11 when viewed from the front. Part (b) of FIG. 5 illustrates side surface 11 in part (a) of FIG. and electrode insulating layer 21 provided on side surface 11. In other words, part (b) of FIG. 5 is a side view of battery 1 in FIG. 1 when viewed from the negative side of the x-axis through transparent counter-electrode terminal 31. Note that part (c) of FIG. 5 is a side view of battery 1 on the x-axis negative side, and outer counter-electrode current collector 41, outer electrode current collector 42, and insulating layer 50 are not shown.

As shown in part (b) of FIG. 5, at side surface 11, electrode insulating layer 21 covers electrode layer 110 of each of battery cells 100. Electrode insulating layer 21 does not cover at least a part of counter-electrode layer 120 of each of battery cells 100. Accordingly, in plan view of side surface 11, electrode insulating layer 21 has a stripe shape.

In doing so, electrode insulating layer 21 continuously covers electrode layers 110 of two adjacent battery cells 100. More specifically, electrode insulating layer 21 continuously covers from a part of counter-electrode layer 120 of one of two adjacent battery cells 100 to a part of counter-electrode layer 120 of the other of two adjacent battery cells 100.

As described above, electrode insulating layer 21 covers a part of counter-electrode layer 120 and solid electrolyte layer 130 at side surface 11. More specifically, in plan view of side surface 11, the contour of electrode insulating layer 21 overlaps with counter-electrode active material layer 122 of counter-electrode layer 120. With this, even when the width (the length in the z-axis direction) varies depending on manufacturing variation of electrode insulating layer 21, electrode layer 110 is unlikely to be exposed. Accordingly, it is possible to prevent electrode layer 110 and counter-electrode layer 120 from being short-circuited through counter-electrode terminal 31 that is formed to cover electrode insulating layer 21. The end surface of counter-electrode active material layer 122 including a powder-like material has very fine unevenness. Accordingly, electrode insulating layer 21 penetrates into this unevenness, thereby improving the adhesion strength of electrode insulating layer 21 and enhancing the reliability of insulation. Note that electrode insulating layer 21 may cover entire counter-electrode active material layer 122. In other words, the contour of electrode insulating layer 21 may overlap with the boundary between counter-electrode active material layer 122 and counter-electrode current collector 121.

As shown in part (b) of FIG. 5, electrode insulating layer 21 is provided to extend along the z-axis at the end portions of the stripe-shaped part in the y-axis direction. In other words, in plan view of side surface 11, electrode insulating layer 21 may be ladder-shaped.

Counter-electrode insulating layer 22 is one example of the second insulating member. As shown in FIG. 1, counter-electrode insulating layer 22 covers counter-electrode layer 120 at side surface 12. More specifically, counter-electrode insulating layer 22 completely covers counter-electrode current collector 121 and counter-electrode active material layer 122 at side surface 12.

FIG. 6 is a side view illustrating a positional relationship between side surface 12 of power generation element 10 and counter-electrode insulating layer 22 provided on side surface 12, according to Embodiment 1. FIG. 6 schematically illustrates a half of the cylindrical side surface of power generation element 10 on the x-axis positive side. Part (a) of FIG. 6 is a side view of power generation element 10, and also a plan view of side surface 12 when viewed from the front. Part (b) of FIG. 6 illustrates side surface 12 in part (a) of FIG. 6 and counter-electrode insulating layer 22 provided on side surface 12. In other words, part (b) of FIG. 6 is a side view of battery 1 in FIG. 1 when viewed from the positive side of the x-axis through transparent electrode terminal 32. Note that part (c) of FIG. 6 is a side view of battery 1 on the x-axis positive side, and outer counter-electrode current collector 41, outer electrode current collector 42, and insulating layer 50 are not shown.

As shown in part (b) of FIG. 6, at side surface 12, counter-electrode insulating layer 22 covers counter-electrode layer 120 of each of battery cells 100. Counter-electrode insulating layer 22 does not cover at least a part of electrode layer 110 of each of battery cells 100. Accordingly, in plan view of side surface 12, counter-electrode insulating layer 22 has a stripe shape.

In doing so, counter-electrode insulating layer 22 continuously covers counter-electrode layers 120 of two adjacent battery cells 100. More specifically, electrode insulating layer 22 continuously covers from a part of electrode layer 110 of one of two adjacent battery cells 100 to a part of electrode layer 110 of the other of two adjacent battery cells 100.

As described above, counter-electrode insulating layer 22 covers a part of electrode layer 110 and solid electrolyte layer 130 at side surface 12. More specifically, in plan view of side surface 12, the contour of counter-electrode insulating layer 22 overlaps with electrode active material layer 112 of electrode layer 110. With this, even when the width (the length in the z-axis direction) varies depending on manufacturing variation of counter-electrode insulating layer 22, counter-electrode layer 120 is unlikely to be exposed. Accordingly, it is possible to prevent counter-electrode layer 120 and electrode layer 110 from being short-circuited through electrode terminal 32 that is formed to cover counter-electrode insulating layer 22. The end surface of electrode active material layer 112 including a powder-like material has very fine unevenness. Accordingly, counter-electrode insulating layer 22 penetrates into this unevenness, thereby improving the adhesion strength of counter-electrode insulating layer 22 and enhancing the reliability of insulation. Note that counter-electrode insulating layer 22 may cover entire electrode active material layer 112. In other words, the contour of counter-electrode insulating layer 22 may overlap with the boundary between electrode active material layer 112 and electrode current collector 111.

As shown in part (b) of FIG. 6, counter-electrode insulating layer 22 is provided to extend along the z-axis at the end portions of the stripe-shaped part in the y-axis direction. In other words, in plan view of side surface 12, counter-electrode insulating layer 22 may be ladder-shaped.

Each of electrode insulating layer 21 and counter-electrode insulating layer 22 is formed using an insulating material that has electrical insulating property. For example, each of electrode insulating layer 21 and counter-electrode insulating layer 22 includes a resin. The resin is, for example, an epoxy resin material, but not limited to this. Note that an inorganic material may be used as the insulating material. Available insulating materials are selected based on various properties such as flexibility, a gas barrier property, impact resistance, and heat resistance. Electrode insulating layer 21 and counter-electrode insulating layer 22 are each formed using the same material. In other words, electrode insulating layer 21 and counter-electrode insulating layer 22 may be integrally formed, and need not be distinguished. Note that electrode insulating layer 21 and counter-electrode insulating layer 22 may be each formed using a different material.

[3. Terminal]

Next, counter-electrode terminal 31 and electrode terminal 32 are described.

Counter-electrode terminal 31 is one example of the first terminal electrode. As shown in FIG. 1, counter-electrode terminal 31 covers side surface 11 and electrode insulating layer 21 to be electrically connected to counter-electrode layer 120. More specifically, counter-electrode terminal 31 covers electrode insulating layer 21 and a part of side surface 11 that is not covered by electrode insulating layer 21.

As shown in part (b) of FIG. 5, in the part of side surface 11 that is not covered by electrode insulating layer 21, the end surface of counter-electrode current collector 121 and a part of the end surface of counter-electrode active material layer 122 are exposed. Accordingly, counter-electrode terminal 31 is in contact with the end surface of counter-electrode current collector 121 and the end surface of counter-electrode active material layer 122 to be electrically connected to counter-electrode layer 120. Counter-electrode terminal 31 penetrates into the unevenness on the end surface of counter-electrode active material layer 122, thereby improving the adhesion strength of counter-electrode terminal 31 and enhancing the reliability of electrical connection.

Counter-electrode terminal 31 is electrically connected to counter-electrode layer 120 of each of battery cells 100. In other words, counter-electrode terminal 31 plays a part of the function of electrically connecting battery cells 100 in parallel. As shown in FIG. 1, counter-electrode terminal 31 covers almost entire side surface 11 at once in the stacking direction. In plan view, as shown in FIG. 2, counter-electrode terminal 31 covers about a quarter of the cylindrical side surface of power generation element 10. Note that the size of counter-electrode terminal 31 is not particularly limited as long as counter-electrode terminal 31 is not in contact with electrode terminal 32. In the present embodiment, counter-electrode layer 120 is the positive electrode, and thus counter-electrode terminal 31 serves as the positive-electrode extraction electrode of battery 1.

Electrode terminal 32 is one example of the second terminal electrode. As shown in FIG. 1, electrode terminal 32 covers side surface 12 and counter-electrode insulating layer 22 to be electrically connected to electrode layer 110. More specifically, electrode terminal 32 covers counter-electrode insulating layer 22 and a part of side surface 12 that is not covered by counter-electrode insulating layer 22.

As shown in part (b) of FIG. 6, in the part of side surface 12 that is not covered by counter-electrode insulating layer 22, the end surface of electrode current collector 111 and a part of the end surface of electrode active material layer 112 are exposed. Accordingly, electrode terminal 32 is in contact with the end surface of electrode current collector 111 and the end surface of electrode active material layer 112 to be electrically connected to electrode layer 110. Electrode terminal 32 penetrates into the unevenness on the end surface of electrode active material layer 112, thereby improving the adhesion strength of electrode terminal 32 and enhancing the reliability of electrical connection.

Electrode terminal 32 is electrically connected to electrode layer 110 of each of battery cells 100. In other words, electrode terminal 32 plays a part of the function of electrically connecting battery cells 100 in parallel. As shown in FIG. 1, electrode terminal 32 covers almost entire side surface 12 at once in the stacking direction. In plan view, as shown in FIG. 2, electrode terminal 32 covers about a quarter of the cylindrical side surface of power generation element 10. Note that the size of electrode terminal 32 is not particularly limited as long as electrode terminal 32 is not in contact with counter-electrode terminal 31. In Embodiment 1, electrode layer 110 is the negative electrode, and thus electrode terminal 32 serves as the negative-electrode extraction electrode of battery 1.

Counter-electrode terminal 31 and electrode terminal 32 are formed using a resin material or the like that is conductive. Alternatively, counter-electrode terminal 31 and electrode terminal 32 may be formed using a metal material such as solder. Available conductive materials are selected based on various properties such as flexibility, a gas barrier property, impact resistance, heat resistance, and solder wettability. Counter-electrode terminal 31 and electrode terminal 32 are each formed using the same material, but may be each formed using a different material.

As described above, counter-electrode terminal 31 and electrode terminal 32 each not only serve as the positive-electrode extraction electrode or the negative-electrode extraction electrode of battery 1, but also play a part of the function of connecting battery cells 100 in parallel. As shown in FIG. 1, counter-electrode terminal 31 and electrode terminal 32 are formed to be in close contact with and cover side surface 11 and side surface 12 of power generation element 10, respectively. Accordingly, it is possible to reduce these volumes. In other words, in comparison with the conventional tub electrode for current collection, the volume of the terminal electrode is reduced. Accordingly, it is possible to improve the energy density per volume of battery 1.

[4. Outer Current Collector]

Next, outer counter-electrode current collector 41 and outer electrode current collector 42 are described.

Outer counter-electrode current collector 41 is disposed at main surface 15 of power generation element 10. As shown in FIG. 1, outer counter-electrode current collector 41 includes flat plate portion 41a disposed above main surface 15 and extended portion 41b extending outward beyond main surface 15. Note that “outward” is a direction away from the center of power generation element 10.

In plan view of main surface 15, flat plate portion 41a overlaps with main surface 15. Extended portion 41b is an example of the first extended portion. In the plan view, extended portion 41b does not overlap with main surface 15. Extended portion 41b and flat plate portion 41a are integrally formed.

Extended portion 41b is bent with respect to flat plate portion 41a, and is in contact with counter-electrode terminal 31. With this, counter-electrode terminal 31 and outer counter-electrode current collector 41 are electrically connected. In other words, outer counter-electrode current collector 41 is electrically connected to counter-electrode layer 120 of each of battery cells 100 through counter-electrode terminal 31.

In the present embodiment, main surface 15 of power generation element 10 is the main surface of electrode current collector 111. Accordingly, insulating layer 50 is provided between flat plate portion 41a of outer counter-electrode current collector 41 and main surface 15. With this, it is possible to prevent a short circuit between outer counter-electrode current collector 41 and electrode layer 110.

As shown in FIG. 2, the shape of flat plate portion 41a in plan view is circular, and flat plate portion 41a covers almost entire power generation element 10. Extended portion 41b is a tongue-like part protruding from a part of the outer circumference of flat plate portion 41a, and is bent toward counter-electrode terminal 31 to come in contact with counter-electrode terminal 31.

Outer electrode current collector 42 has the same configuration as outer counter-electrode current collector 41. More specifically, outer electrode current collector 42 is disposed at main surface 16 of power generation element 10. As shown in FIG. 1, outer electrode current collector 42 includes flat plate portion 42a provided below main surface 16 and extended portion 42b extending outward beyond main surface 16.

In plan view of main surface 16, flat plate portion 42a overlaps with main surface 16. Extended portion 42b is an example of the second extended portion. In the plan view, extended portion 42b does not overlap with main surface 16. Extended portion 42b and flat plate portion 42a are integrally formed.

Extended portion 42b is bent with respect to flat plate portion 42a, and is in contact with electrode terminal 32. With this, electrode terminal 32 and outer electrode current collector 42 are electrically connected. In other words, outer electrode current collector 42 is electrically connected to electrode layer 110 of each of battery cells 100 through electrode terminal 32.

In the present embodiment, main surface 16 of power generation element 10 is the main surface of electrode current collector 111. Accordingly, flat plate portion 42a of outer electrode current collector 42 is in direct contact with main surface 16. With this, the contact area is increased, and thus the connection resistance is decreased. Accordingly, it is possible to improve the high current characteristics of battery 1.

The shape of flat plate portion 42a in plan view is circular, and flat plate portion 42a covers almost entire power generation element 10. Extended portion 42b is a tongue-like part protruding from a part of the outer circumference of flat plate portion 42a, and is bent toward electrode terminal 32 to come in contact with electrode terminal 32. As shown in FIG. 2, in plan view, extended portion 42b is arranged so that the center of power generation element 10 is located on the line connecting extended portion 41b and extended portion 42b. Extended portion 41b and extended portion 42b can be separated, and thus it is possible to prevent a short circuit.

Outer counter-electrode current collector 41 and outer electrode current collector 42 are each a plate-shaped or foil-shaped metal member. For example, the metal member includes a metal such as Al, Fe, SUS, Ni, or Cu. Outer counter-electrode current collector 41 and outer electrode current collector 42 may be each formed using the same material or a different material.

[5. Insulating Layer]

Next, insulating layer 50 is described.

Insulating layer 50 is located between outer counter-electrode current collector 41 and main surface 15 of power generation element 10. Insulating layer 50 is provided to ensure electrical insulation between outer counter-electrode current collector 41 and electrode current collector 111 which forms main surface 15 of power generation element 10. For example, insulating layer 50 covers entire main surface 15.

Insulating layer 50 is a common insulating member such as a resin film. For example, insulating layer 50 is a polyethylene terephthalate (PET) film, a polyethylene naphthalate (PEN) film, or a polyimide film. Insulating layer 50 may include a metal oxide. Moreover, an adhesive layer for improving the adhesion to power generation element 10 or outer counter-electrode current collector 41 may be provided on the surface of insulating layer 50. For example, the adhesive layer is formed using an acrylic resin or the like.

[6. Example of Application]

Next, the following describes an example of application of battery 1 according to the present embodiment. For example, battery 1 is applied to a coin battery or a laminated battery.

[6-1. Coin Battery]

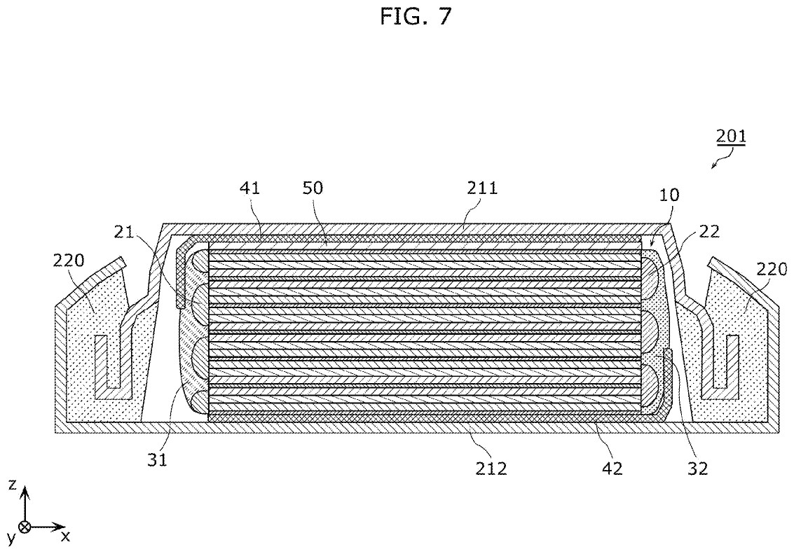

FIG. 7 is a cross-sectional view of coin battery 201 including battery 1 according to the present embodiment. Coin battery 201 is also referred to as a button battery. As shown in FIG. 7, coin battery 201 includes battery 1, sealing plate 211, outer can 212, and gasket 220.

Battery 1 is accommodated in outer can 212, and covered by sealing plate 211. Sealing plate 211 and outer can 212 are each formed using a conductive material such as a metal. Sealing plate 211 is in contact with outer counter-electrode current collector 41 of battery 1. Outer can 212 is in contact with outer electrode current collector 42 of battery 1. In other words, sealing plate 211 and outer can 212 serve as the positive electrode and the negative electrode of battery 1, respectively. Gasket 220 is a component for insulating electrical contact between outer can 212 and sealing plate 211 and sealing battery 1 inside outer can 212.

As described above, according to the present embodiment, coin battery 201 including battery 1 including multiple battery cells 100 can be achieved. It is possible to achieve increased capacity and long-term reliability while reducing risk of a short circuit of coin battery 201.

[6-2. Laminated Battery]

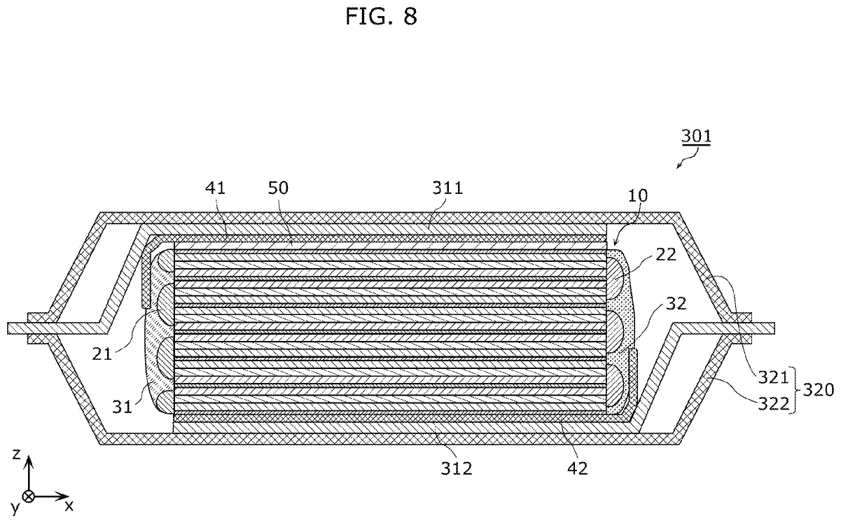

FIG. 8 is a cross-sectional view of laminated battery 301 including battery 1 according to the present embodiment. As shown in FIG. 8, laminated battery 301 includes battery 1, counter-electrode external terminal 311, electrode external terminal 312, and outer body 320.

Counter-electrode external terminal 311 and electrode external terminal 312 are connected to battery 1. Battery 1 is sealed by outer body 320.

Counter-electrode external terminal 311 and electrode external terminal 312 are the positive-electrode extraction electrode and the negative-electrode extraction electrode of battery 1 to the outside, respectively. Counter-electrode external terminal 311 and electrode external terminal 312 are each partly drawn to the outside of outer body 320.

Counter-electrode external terminal 311 is in contact with outer counter-electrode current collector 41. With this, counter-electrode external terminal 311 is electrically connected to counter-electrode layers 120 of battery cells 100 of power generation element 10 through outer counter-electrode current collector 41 and counter-electrode terminal 31.

Electrode external terminal 312 is in contact with outer electrode current collector 42. With this, electrode external terminal 312 is electrically connected to electrode layers 110 of battery cells 100 of power generation element 10 through outer electrode current collector 42 and electrode terminal 32.

Counter-electrode external terminal 311 and electrode external terminal 312 are each a plate-shaped or foil-shaped metal member. For example, the metal member includes a metal such as Al, Fe, SUS, Ni, or Cu. Counter-electrode external terminal 311 and electrode external terminal 312 may be each formed using the same material or a different material.

Outer body 320 includes two laminate films 321 and 322, Two laminate films 321 and 322 sandwich and seal battery 1. As each of two laminate films 321 and 322, a common laminate film material can be used. Note that outer body 320 may be formed by bending one laminate film.

As described above, according to the present embodiment, laminated battery 301 including battery 1 including multiple battery cells 100 can be achieved. It is possible to achieve increased capacity and long-term reliability while reducing risk of a short circuit of laminated battery 301.

Moreover, outer body 320 may be a metal can or a box formed using a resin material. In this case, counter-electrode external terminal 311 and electrode external terminal 312 may be each a rod-shaped metal material.

Note that, in laminated battery 301, the shape of power generation element 10 in plan view need not be circular. For example, the shape of power generation element 10 in plan view may be polygonal such as rectangular, square, hexagonal, or octagonal, or may be oval.

[7. Variations]

Next, variations of the embodiment are described.

The embodiment shows the case where all battery cells 100 are electrically connected in parallel. In contrast, the present variations show the case where some of battery cells 100 are electrically connected in parallel.

[7-1. Variation 1]

First, a battery according to Variation 1 is described.

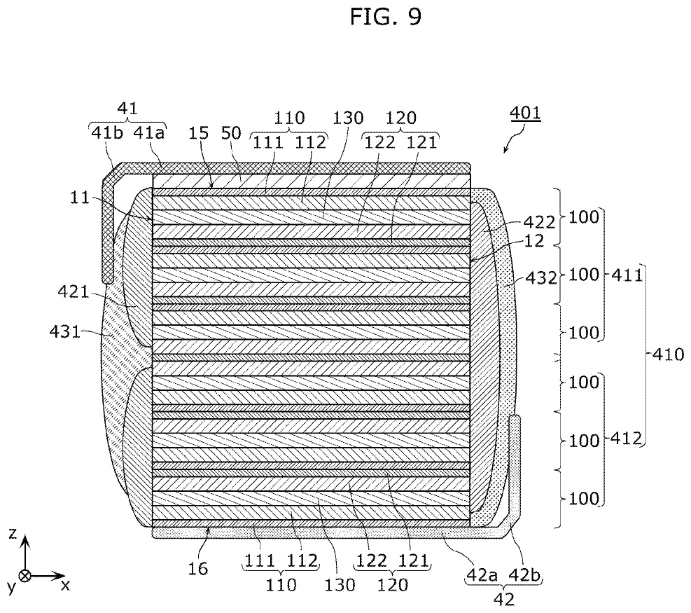

FIG. 9 is a cross-sectional view illustrating a cross-sectional configuration of battery 401 according to Variation 1. Battery 401 shown in FIG. 9 includes power generation element 410 including six battery cells 100 having a relationship of 3-series 2-parallel connection. Here, “A-series B-parallel” means that B layered bodies each including A battery cells connected in series are connected in parallel. In other words, in power generation element 410 of “3-series 2-parallel”, two series layered bodies 411 and 412 are each formed by three battery cells 100 electrically connected in series. Two series layered bodies 411 and 412 are connected in parallel. Note that power generation element 10 shown in FIG. 1 can be regarded as a power generation element of “1-series 6-parallel”.

Three battery cells 100 included in series layered body 411 have the same order of arrangement of the layers of each battery cell. In other words, in any of three battery cells 100 included in series layered body 411, counter-electrode current collector 121, counter-electrode active material layer 122, solid electrolyte layer 130, electrode active material layer 112, and electrode current collector 111 are arranged in this order toward the top (in the positive direction of the z-axis). Electrode current collector 111 and counter-electrode current collector 121 of two adjacent battery cells 100 are in direct contact with each other.

Three battery cells 100 included in series layered body 412 have the same order of arrangement of the layers of each battery cell. This order is the reverse order of arrangement of the layers of battery cell 100 included in series layered body 411. In other words, in any of three battery cells 100 included in series layered body 412, electrode current collector 111, electrode active material layer 112, solid electrolyte layer 130, counter-electrode active material layer 122, and counter-electrode current collector 121 are arranged in this order toward the top (in the positive direction of the z-axis). Electrode current collector 111 and counter-electrode current collector 121 of two adjacent battery cells 100 are in direct contact with each other. Note that, in series layered bodies 411 and 412, electrode current collector 111 and counter-electrode current collector 121 which are in contact with each other may be one current collector.

Lowermost counter-electrode current collector 121 of series layered body 411 and uppermost counter-electrode current collector 121 of series layered body 412 are shared with each other. With this, the counter electrodes of two series layered bodies 411 and 412 are electrically connected to each other.

In Variation 1, battery 401 includes electrode insulating layer 421, counter-electrode insulating layer 422, counter-electrode terminal 431, and electrode terminal 432.

Electrode insulating layer 421 covers electrode layer 110 at side surface 11. More specifically, electrode insulating layer 421 covers the remainder of: center counter-electrode current collector 121 shared between two series layered bodies 411 and 412; and parts of counter-electrode active material layers 122 located on opposite sides of center counter-electrode current collector 121. More specifically, electrode insulating layer 421 continuously covers from the uppermost layer of series layered body 411 to a part of counter-electrode active material layer 122 located on the top-surface side of center counter-electrode current collector 121. Furthermore, electrode insulating layer 421 continuously covers from the lowermost layer of series layered body 412 to a part of counter-electrode active material layer 122 located on the bottom-surface side of center counter-electrode current collector 121.

In Variation 1, counter-electrode terminal 431 covers electrode insulating layer 421 and a part of side surface 11 that is not covered by electrode insulating layer 421. More specifically, counter-electrode terminal 431 is in contact with center counter-electrode current collector 121, to be electrically connected. With this, it is possible to ensure an electrical connection to counter-electrode current collector 121 while preventing a short circuit between counter-electrode terminal 431 and electrode layer 110.

Counter-electrode insulating layer 422 covers counter-electrode layer 120 at side surface 12. More specifically, counter-electrode insulating layer 422 covers the remainder of: at least a part of electrode layer 110 located at the uppermost layer of series layered body 411; and at least a part of electrode layer 110 located at the lowermost layer of series layered body 412. More specifically, counter-electrode insulating layer 422 continuously covers from a part of electrode active material layer 112 in electrode layer 110 located at the uppermost layer of series layered body 411 to a part of electrode active material layer 112 in electrode layer 110 located at the lowermost layer of series layered body 412. Counter-electrode insulating layer 422 does not cover electrode current collectors 111 of the uppermost layer and the lowermost layer.

In Variation 1, electrode terminal 432 covers counter-electrode insulating layer 422 and a part of side surface 12 that is not covered by counter-electrode insulating layer 422. More specifically, electrode terminal 432 is in contact with electrode current collectors 111 of the uppermost layer and the lowermost layer, to be electrically connected. With this, it is possible to ensure an electrical connection to electrode current collector 111 while preventing a short circuit between electrode terminal 432 and counter-electrode layer 120.

As described above, also in battery 401 including battery cells 100 connected in series, the electrical connection and the electrode extraction using the side surface of power generation element 410 can be made. As with battery 1 according to the embodiment, it is possible to improve the adhesion strength of the insulating layer and enhance the reliability of battery 401.

[7-2. Variation 2]

First, a battery according to Variation 2 is described.

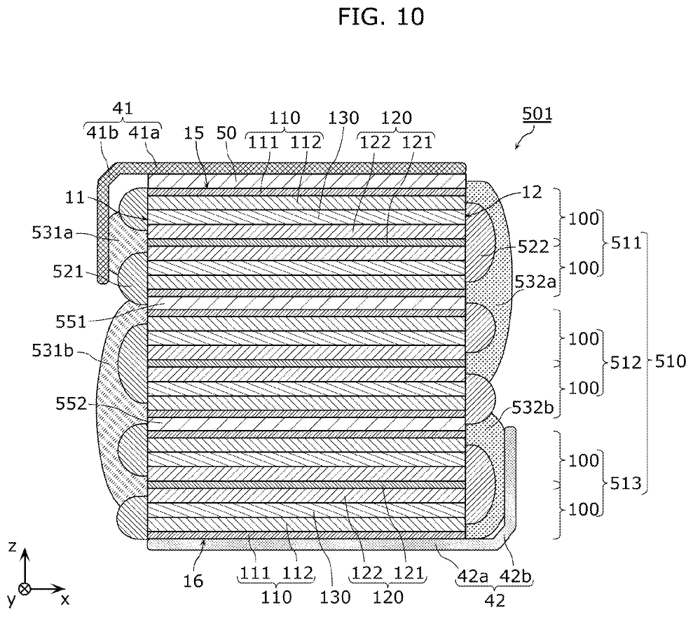

FIG. 10 is a cross-sectional view illustrating a cross-sectional configuration of battery 501 according to Variation 2. Battery 501 shown in FIG. 10 includes power generation element 510 including six battery cells 100 having a relationship of 2-parallel 3-series connection. Here, “A-parallel B-series” means that B layered bodies each including A battery cells connected in parallel are connected in series. In other words, in power generation element 510 of “2-parallel 3-series”, three parallel layered bodies 511, 512, and 513 are each formed by two battery cells 100 electrically connected in parallel. Three parallel layered bodies 511, 512, and 513 are connected in series.

In two battery cells 100 included in parallel layered body 511, the order of arrangement of the layers of each battery cell is reversed. Two battery cells 100 share counter-electrode current collector 121 at the center of the stacking direction. Parallel layered bodies 512 and 513 also have the same configuration as parallel layered body 511.

In Variation 2, battery 501 includes electrode insulating layer 521, counter-electrode insulating layer 522, counter-electrode terminals 531a and 531b, electrode terminals 532a and 532b, and insulating layers 551 and 552.

Electrode insulating layer 521 covers electrode layer 110 at side surface 11. As with electrode insulating layer 21 according to the embodiment, electrode insulating layer 521 covers all electrode layers 110 and all solid electrolyte layers 130 at side surface 11. Electrode insulating layer 521 does not cover counter-electrode current collector 121 and a part of counter-electrode active material layer 122 of each of counter-electrode layers 120. Note that electrode insulating layer 521 also covers a part of insulating layers 551 and 552 at side surface 11, but the present disclosure is not limited to this.

Counter-electrode insulating layer 522 covers counter-electrode layer 120 at side surface 12. As with counter-electrode insulating layer 522 according to the embodiment, counter-electrode insulating layer 522 covers all counter-electrode layers 120 and all solid electrolyte layers 130. Counter-electrode insulating layer 522 does not cover electrode current collector 111 and a part of electrode active material layer 112 of each of electrode layers 110. Note that counter-electrode insulating layer 522 also covers a part of insulating layers 551 and 552 at side surface 12, but the present disclosure is not limited to this.

Counter-electrode terminals 531a and 531b each cover electrode insulating layer 521 and a part of side surface 11 that is not covered by electrode insulating layer 521. More specifically, counter-electrode terminal 531a is in contact with counter-electrode current collector 121 of parallel layered body 511, to be electrically connected. Counter-electrode terminal 531b is in contact with counter-electrode current collector 121 of each of parallel layered bodies 512 and 513, to be electrically connected. Counter-electrode terminal 531a and counter-electrode terminal 531b are not in contact with each other, to be electrically insulated. Outer counter-electrode current collector 41 is connected to counter-electrode terminal 531a, and not connected to counter-electrode terminal 531b. With this, the parallel layered bodies can be connected in series while preventing a short circuit between counter-electrode terminal 531a and electrode layer 110 and a short circuit between counter-electrode terminal 531b and electrode layer 110.

Electrode terminals 532a and 532b each cover counter-electrode insulating layer 522 and a part of side surface 12 that is not covered by counter-electrode insulating layer 522. More specifically, electrode terminal 532a is in contact with electrode current collectors 111 of parallel layered bodies 511 and 512, to be electrically connected. Electrode terminal 532b is in contact with electrode current collectors 111 of parallel layered body 513, to be electrically connected. Electrode terminal 532a and electrode terminal 532b are not in contact with each other, to be electrically insulated. Outer electrode current collector 42 is connected to electrode terminal 532b, and not connected to electrode terminal 532a. With this, the parallel layered bodies can be connected in series while preventing a short circuit between electrode terminal 532a and counter-electrode layer 120 and a short circuit between electrode terminal 532b and counter-electrode layer 120.

Insulating layers 551 and 552 are each arranged between two adjacent parallel layered bodies. Insulating layers 551 and 552 are provided to prevent the parallel layered bodies from being in contact with each other so that the parallel layered bodies are electrically connected through the electrode terminals and the counter-electrode terminals. For example, insulating layers 551 and 552 are formed using the same material as insulating layer 50. Alternatively, insulating layers 551 and 552 may be formed using an adhesive resin material such as an acrylic resin.

As described above, also in battery 501 including battery cells 100 connected in series, the electrical connection and the electrode extraction using the side surface of power generation element 510 can be made. As with battery 1 according to the embodiment, it is possible to improve the adhesion strength of the insulating layer and enhance the reliability of battery 501.

[8. Manufacturing Method]

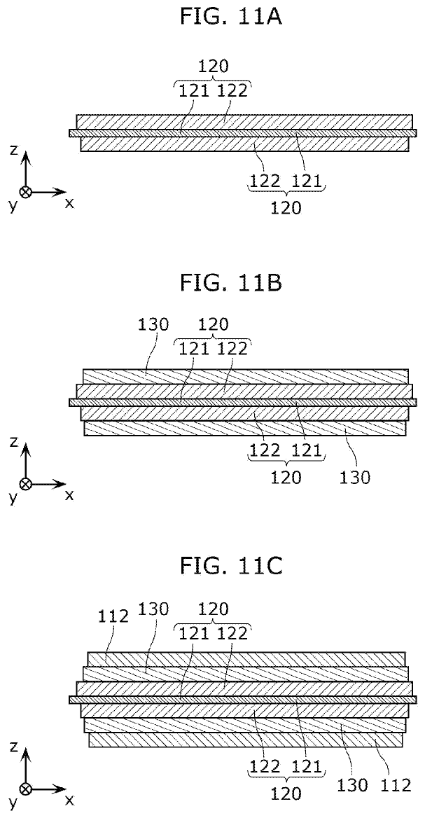

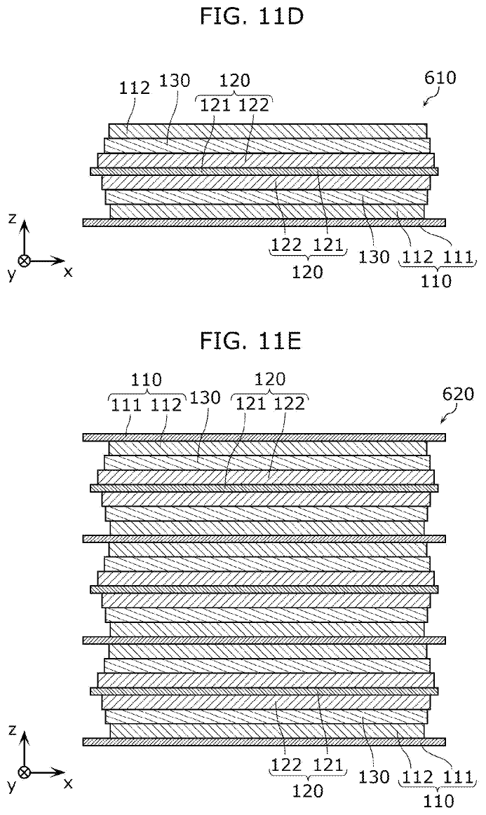

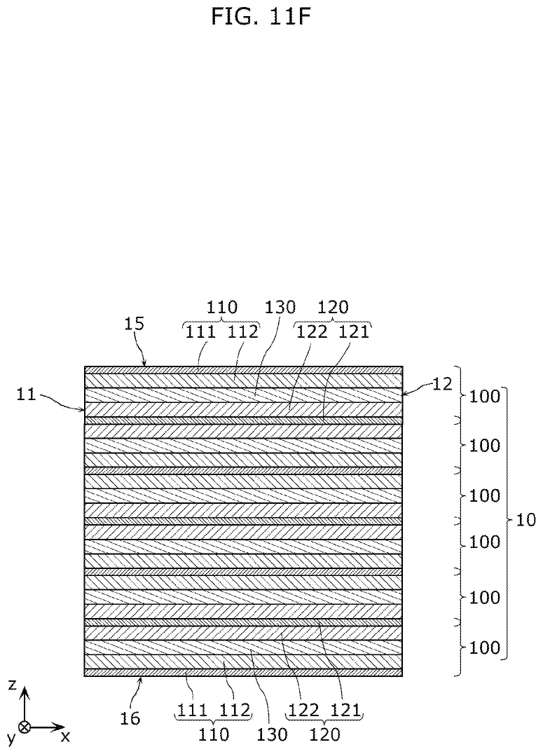

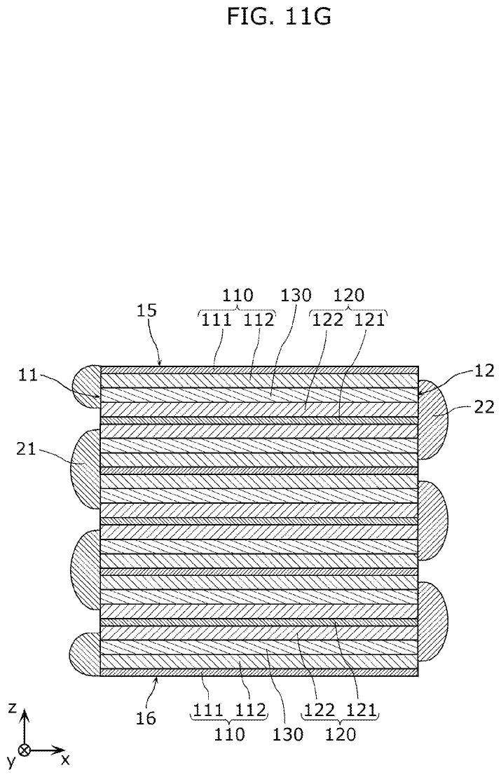

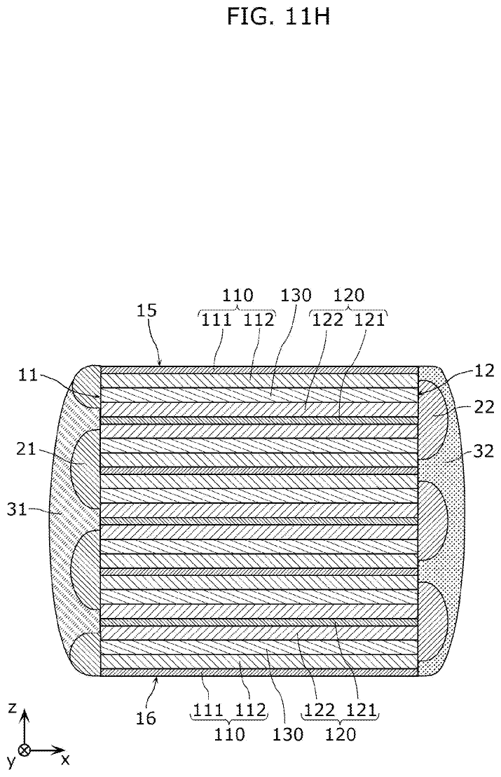

Next, a method of manufacturing the battery according to the embodiment or each variation is described with reference to FIG. 11A through FIG. 11H. FIG. 11A through FIG. 11H are each a cross-sectional view illustrating a step of the method of manufacturing the battery according to the embodiment or each variation.

First, a paste-like paint in which a counter-electrode material is kneaded together with a solvent is prepared. This paint is applied on both surfaces of counter-electrode current collector 121. The counter-electrode material is a material which forms counter-electrode active material layer 122. In this manner, as shown in FIG. 11A, two counter-electrode layers 120 sharing counter-electrode current collector 121 are formed. Note that, in the case where electrode current collector 111 is shared, this can be formed using electrode current collector 111 and an electrode material in a similar manner. Here, the electrode material is a material which forms electrode active material layer 112.

Next, a solid electrolyte material is applied on the main surface of counter-electrode active material layer 122 to cover the applied paint and is dried. The solid electrolyte material is a material which forms solid electrolyte layer 130. In this manner, as shown in FIG. 11B, solid electrolyte layer 130 is formed.

Next, a paste-like paint in which an electrode material is kneaded together with a solvent is prepared. This paint is applied on the main surface of solid electrolyte layer 130. In this manner, as shown in FIG. 11C, electrode active material layer 112 is formed. Note that each of the counter-electrode material, the electrode material, and the solid electrolyte material may be prepared using a material that contains no solvent.

As the applying method for forming electrode active material layer 112, counter-electrode active material layer 122, and solid electrolyte layer 130, a screen printing method, a die coating method, a spray method, a gravure printing method, or the like is used, but the present disclosure is not limited to these methods.

Next, electrode current collector 111 is stacked on one of electrode active material layers 112 to be bonded. In this manner, as shown in FIG. 11D, layered unit 610 is obtained.

Next, three layered units 610 are stacked so that electrode active material layer 112 and electrode current collector 111 are in contact with each other. Furthermore, electrode current collector 111 is stacked on electrode active material layer 112 to be in contact with each other. In this manner, as shown in FIG. 11E, middle layered body 620 is obtained.

Next, a cutting process is performed on the end portions to make middle layered body 620 a desired battery size. In this manner, as shown in FIG. 11F, power generation element 10 which is a layered body of battery cells 100 is obtained. The cutting process is performed on the end portions, and thus, in plan view, electrode active material layer 112, counter-electrode active material layer 122, solid electrolyte layer 130, electrode current collector 111, and counter-electrode current collector 121 can have the same area without a protrusion. In this manner, it is possible to maximize the battery capacity while preventing risk of a short circuit and enhancing the reliability. The cutting process is performed using knife, laser, jet, or the like.

Next, as shown in FIG. 11G, electrode insulating layer 21 and counter-electrode insulating layer 22 are formed on side surfaces 11 and 12 of power generation element 10. The insulating layer is formed, for example, by applying and curing an insulating material. More specifically, the forming method includes a screen printing method, a gravure printing method, a spray method, a dispensing method, and the like, but the present disclosure is not limited to these methods.

In doing so, it is important that an end portion on which electrode insulating layer 21 is applied is located at the end surface of counter-electrode active material layer 122. The end surface of counter-electrode active material layer 122 including a powder-like material has very fine unevenness. This improves the adhesion strength of electrode insulating layer 21 and enhances the reliability of insulation.

Likewise, it is important that an end portion on which counter-electrode insulating layer 22 is applied is located at the end surface of electrode active material layer 112. The end surface of electrode active material layer 112 including a powder-like material has very fine unevenness. This improves the adhesion strength of counter-electrode insulating layer 22 and enhances the reliability of insulation.

Next, as shown in FIG. 11H, counter-electrode terminal 31 and electrode terminal 32 are formed on the side surfaces of power generation element 10 to cover electrode insulating layer 21 and counter-electrode insulating layer 22, respectively. The terminals are formed, for example, by applying and curing a conductive material. More specifically, the forming method includes a screen printing method, a gravure printing method, a spray method, a dispensing method, and the like, but the present disclosure is not limited to these methods.

In doing so, it is important that an end portion on which electrode terminal 32 is applied to power generation element 10 at a contact surface is located at the end surface of electrode active material layer 112. The end surface of electrode active material layer 112 including a powder-like material has very fine unevenness. This improves the adhesion strength of electrode terminal 32 and enhances the long-term reliability of the properties.

Likewise, it is important that an end portion on which counter-electrode terminal 31 is applied to power generation element 10 at a contact surface is located at the end surface of counter-electrode active material layer 122. The end surface of counter-electrode active material layer 122 including a powder-like material has very fine unevenness. This improves the adhesion strength of counter-electrode terminal 31 and enhances the long-term reliability of the properties.

Next, battery 1 shown in FIG. 1 is obtained by stacking insulating layer 50, outer counter-electrode current collector 41, and outer electrode current collector 42.

In the manufacturing method described above, for example, forgoing battery 1 can be manufactured.

Note that the manufacturing method is not limited to the foregoing example. The applying may be performed on only one side of the current collector. Moreover, it is possible to manufacturing battery 401 shown in FIG. 9 or battery 501 shown in FIG. 10 by appropriately adjusting the stacking order of battery cell 100.

### OTHER EMBODIMENTS

Although the battery according to one or more aspects have been described above based on the embodiment, the present disclosure is not limited to this embodiment. Embodiments obtained by performing various types of variations conceived by a person skilled in the art on the present embodiment and embodiments established by combining constituent elements in different embodiments are also included in the scope of the present disclosure without departing from the spirit of the present disclosure.

For example, the number of battery cells 100 included in power generation element 10 is not particularly limited. Moreover, as long as at least two battery cells 100 are connected in parallel, the number of series connections and the number of parallel connections in the connection relationship between battery cells 100 are not particularly limited.

Moreover, although the above embodiments describe a case where the current collector is shared with two adjacent battery cells, the current collector need not be shared. More specifically, multiple battery cells 100A each of which is shown in FIG. 3A may be stacked alongside each other. In this case, two current collectors of the same polarity are overlapped with each other. In doing so, the two current collectors may be in direct contact with each other, or a conductive material or an adhesive material may be provided between the two current collectors.

Moreover, for example, an external electrode may be formed on the topmost surface of each of the electrode terminal and the counter-electrode terminal using a method such as plating, printing, or soldering. With the external electrode provided for the battery, it is possible to further enhance the implementation of the battery.

Moreover, although the above embodiments describe a case where each battery includes both counter-electrode terminal 31 and electrode terminal 32, each battery may include only one of them. In other words, one of the positive electrode and the negative electrode of the battery may be extracted by a tab electrode.

Moreover, for example, in plan view, extended portions 41b and 42b are provided on direct opposite sides with respect to the center of circular main surface 15, but the present disclosure is not limited to this. The angle between extended portion 41b and the center of main surface 15 and the angle between extended portion 42b and the center of main surface 15 may be 90 degrees or less than 90 degrees. Moreover, regarding at least one of extended portions 41b and 42b, plural extended portions may be provided.

Moreover, in the above embodiments, various changes, replacement, addition, omission, and the like can be performed in the scope of claims or a scope equivalent thereto.

### INDUSTRIAL APPLICABILITY

The present disclosure can be utilized, for example, as batteries for electronic devices, electrical apparatuses, electric vehicles, and the like.

1. A battery comprising:
a power generation element including a plurality of battery cells each of which includes an electrode layer, a counter-electrode layer, and a solid electrolyte layer located between the electrode layer and the counter-electrode layer, the plurality of battery cells being stacked;
a first insulating member covering an electrode layer among the electrode layers at a first side surface of the power generation element; and
a first terminal electrode covering the first side surface and the first insulating member, and electrically connected to a counter-electrode layer among the counter-electrode layers, wherein
at least some of the plurality of battery cells are connected in parallel, and
at the first side surface, the first insulating member covers from an electrode layer among the electrode layers to a part of a corresponding one of the counter-electrode layers along a stacking direction of the power generation element.

2. The battery according to claim 1, wherein
the counter-electrode layer includes:
a counter-electrode current collector; and
a counter-electrode active material layer located between the counter-electrode current collector and the solid electrolyte layer, and
the first insulating member covers from the electrode layer to at least a part of the counter-electrode active material layer, and does not cover the counter-electrode current collector.

3. The battery according to claim 2, wherein
a thickness of the counter-electrode current collector is less than or equal to 20 μm.

4. The battery according to claim 1, further comprising:
an outer counter-electrode current collector disposed at a first main surface of the power generation element, wherein
the outer counter-electrode current collector includes a first extended portion extending outward from the first main surface, and
the first extended portion is connected to the first terminal electrode.

5. The battery according to claim 4, further comprising:
an insulating layer located between the outer counter-electrode current collector and the first main surface.

6. The battery according to claim 1, wherein
in plan view, contour of the electrode layer, contour of the counter-electrode layer, and contour of the solid electrolyte layer coincide with one another.

7. The battery according to claim 1, further comprising:
a second insulating member covering a counter-electrode layer among the counter-electrode layers at a second side surface of the power generation element; and
a second terminal electrode covering the second side surface and the second insulating member, and electrically connected to an electrode layer among the electrode layers, wherein
at the second side surface, the second insulating member covers from a counter-electrode layer among the counter-electrode layers to a part of a corresponding one of the electrode layers along the stacking direction of the power generation element.

8. The battery according to claim 7, wherein
the electrode layer includes:
an electrode current collector; and
an electrode active material layer located between the electrode current collector and the solid electrolyte layer, and
the second insulating member covers from the counter-electrode layer to at least a part of the electrode active material layer, and does not cover the electrode current collector.

9. The battery according to claim 8, wherein
a thickness of the electrode current collector is less than or equal to 20 μm.

10. The battery according to claim 7, further comprising:
an outer electrode current collector disposed at a second main surface of the power generation element, wherein
the outer electrode current collector includes a second extended portion extending outward from the second main surface, and
the second extended portion is connected to the second terminal electrode.

11. The battery according to claim 7, wherein
a shape of the power generation element is cylindrical, and
the first side surface and the second side surface are each a different part of a cylindrical side surface.

12. The battery according to claim 1, wherein
all the plurality of battery cells are connected in parallel.

13. The battery according to claim 1, wherein
some of the plurality of battery cells are connected in series.

14. The battery according to claim 1, wherein
the solid electrolyte layer includes a lithium-ion conducting solid electrolyte.

15. The battery according to claim 1, wherein
the battery is a coin battery.

16. The battery according to claim 1, wherein
the battery is sealed with a laminate film.
